(19) United States
(12) Patent Application Publication
(10) Pub. No.: US 2010/0072765 A1
(43) Pub. Date: Mar. 25, 2010

(54) Portable collection device for collecting pet feces

(76) Inventor: Heriberto Granado, Plantation, FL (US)

Correspondence Address: WELSH & FLAXMAN LLC, 2000 DUKE STREET, SUITE 100, ALEXANDRIA, VA, 22314, US

(21) Appl. No.: 12/232,563

(22) Filed: Sep. 19, 2008

(51) Int. Cl. A01K 29/00

(52) U.S. Cl. 294/1.4

(57) ABSTRACT

A portable device for collecting pet feces includes an elongated, support bar having a first end and a second end. The first end of the support bar is provided with a handle for gripping by a user and the second end of the support bar is provided with a bag holder adjustably connected thereto. The bag holder is composed of an inner first ring and an outer second ring that cooperate to function as a clamp to secure a collection bag therebetween for collection of pet feces.

### BACKGROUND OF THE INVENTION

1. Field of the Invention

The invention relates to a portable device for collecting pet feces. In particular, the invention relates to a portable device for collecting pet feces before they hit the ground through the utilization of a disposable bag holder that may be positioned for collection thereof.

2. Description of the Related Art

Dogs provide great pleasure to many people. However, with the ownership of a dog, comes the responsibility of cleaning up after your dog so that the feces do not present a highly undesirable environmental and create health concerns. As such, many devices have been developed for picking up after one's pet. However, many of these devices are cumbersome, expensive or just down right non-functional. As such, a need currently exists for an improved “pooper scooper”. The present invention provides such a device.

### SUMMARY OF THE INVENTION

It is, therefore, an object of the present invention to provide a portable device for collecting pet feces. The device includes an elongated, support bar having a first end and a second end. The first end of the support bar is provided with a handle for gripping by a user and the second end of the support bar is provided with a bag holder adjustably connected thereto. The bag holder is composed of an inner first ring and an outer second ring that cooperate to function as a clamp to secure a collection bag therebetween for collection of pet feces.

It is also an object of the present invention to provide a portable device for collecting pet feces wherein the support bar is adjustable in length.

It is also another object of the present invention to provide a portable device for collecting pet feces wherein the support bar is telescopically adjustable.

It is also a further object of the present invention to provide a portable device for collecting pet feces wherein the inner first ring includes an inner surface and an outer surface, and the outer surface of the inner first ring is provided with a profile that mates with an inner profile of the outer second ring to enhance the interaction between the outer second ring and the inner first ring to help in retaining a collection bag between the inner first ring and the outer second ring.

It is a further object of the present invention to provide a portable device for collecting pet feces wherein the inner first ring and outer second ring are concentrically oriented and maintained in a position such that the inner first ring and the outer second ring stay within the same plane to hold a collection bag therebetween.

It is another object of the present invention to provide a portable device for collecting pet feces wherein the outer second ring is substantially rigid and is coupled to the second end of the support bar, and the inner first ring is substantially compliant and resilient allowing the inner first ring to be selectively placed within the outer second ring, wherein when a collection bag is positioned within the outer second ring, the inner first ring is actuated to its smaller diameter orientation for placement within the outer second ring and released to seat within the outer second ring, the force existing between the inner first ring and the outer second rings retains the collection bag therebetween.

It is also an object of the present invention to provide a portable device for collecting pet feces wherein the outer second ring includes an inner surface and an outer surface, and the inner surface is shaped and dimensioned for receiving and supporting the inner first ring as it expands to contact the inner surface of the outer second ring.

It is still another object of the present invention to provide a portable device for collecting pet feces wherein the handle includes a battery operated light.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a side view of the present portable device for collecting pet feces.

FIG. 2 is a top view showing the bag positioned between the inner first ring and the outer second ring.

FIG. 3 is a cross sectional view along the line 3-3 in FIG. 2.

FIG. 4 is a top view of the outer second ring.

FIG. 5 is a top view of the inner first ring.

FIG. 6 is a detailed view of the area designated by broken lines in FIG. 3.

FIG. 6A is an alternative embodiment to that shown in FIG. 6.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

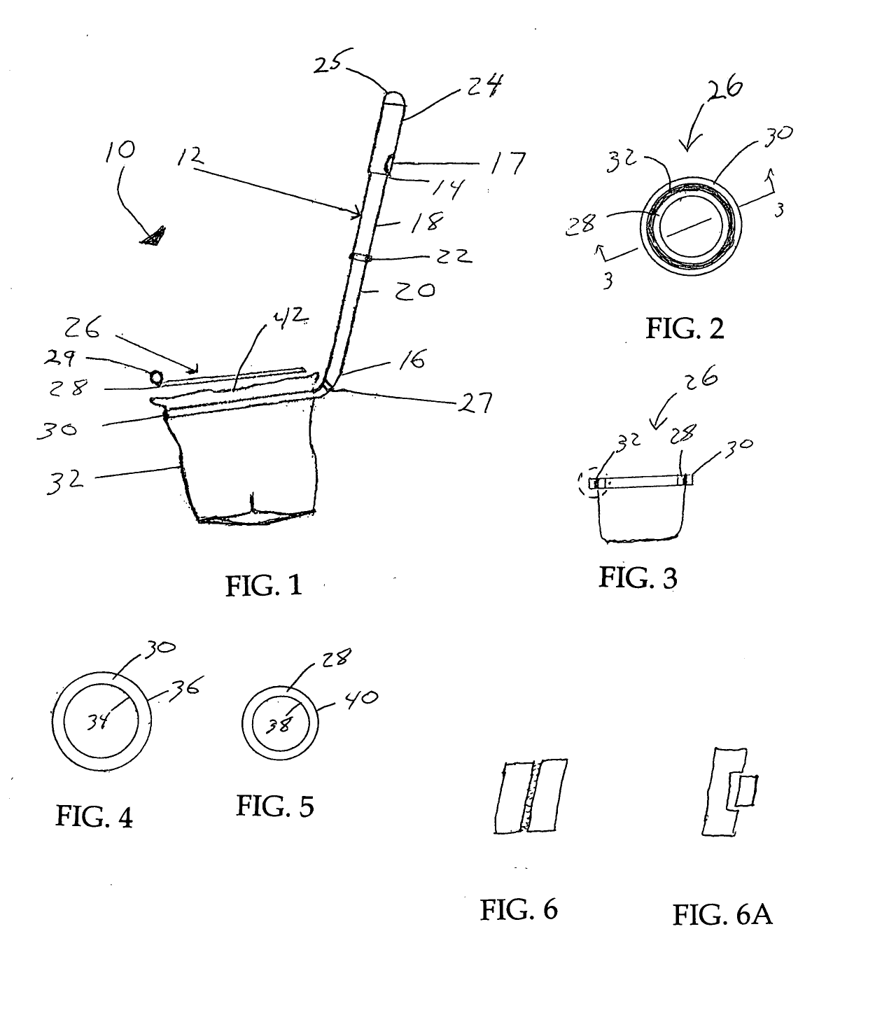

With reference to FIGS. 1 to 5, a portable collection device 10 for collecting pet feces is disclosed. The portable collection device 10 provides a mechanism for collecting pet feces before they hit the ground by positioning a portion of the portable collection device 10 beneath the pet as the pet stops to defecate. As a result the feces are caught by the present portable collection device 10 without having to scoop or otherwise remove the feces from a surface upon which they have landed. In addition, by collecting the feces before they hit the ground, the surface is not even minimally affected by contact with the feces.

Referring to the various figures, the portable collection device 10 generally includes an elongated, telescopically adjustable support bar 12 having a first end 14 and a second end 16. In accordance with a preferred embodiment, the support bar 12 is composed of first and second telescoping members 18, 20 selectively held together at different relative positions via a conventional compression lock member 22 positioned between the first and second telescoping members 18, 20. The use of first and second telescoping members 18, 20 allows the user to selectively extend and retract the support bar 12 for usage by different sized people and retract for storage in a compact manner. While a telescoping support bar is disclosed in accordance with a preferred embodiment of the present invention as a mechanism for adding improved functionality to the present collection device, those skilled in the art will appreciate other support bar constructions could be employed without departing from the spirit of the present invention.

The first end 14 of the support bar 12 is provided with a handle 24 for gripping by a user. The second end 16 of the support bar 12 is connected to a disposable bag holder 26 adjustably connected thereto via a pivotal joint 27, which permits the angle of the bag holder 26 to be adjusted relative to the support bar 12. The bag holder 26 is composed of a pair of cooperating rings 28, 30 which function as a clamp to secure a conventional plastic shopping bag, which functions as a collection bag 32, therebetween for collection of pet feces in the manner discussed below in greater detail. The handle 24 is further equipped with a battery operated light 17 which permits the portable collection device 10 to be more easily manipulated in the dark.

With reference to the various figures, the disposable bag holder 26 includes an inner first ring 28 and an outer second ring 30. When in use, the first and second rings 28, 30 are concentrically oriented and maintained in a position such that the first and second rings 28, 30 stay within the same plane to hold a collection bag 32 therebetween. The outer second ring 30 is substantially solid and is fixedly connected to the second end 16 of the support bar 12, while the inner first ring 28 is substantially compliant allowing the inner first ring 28 to be selectively flexed and placed within the outer second ring 30. The inner first ring 28 is shaped and dimensioned such that it fits within the outer second ring 30 in a manner creating pressure therebetween. As such, when a collection bag 32 is positioned within the outer second ring 30, the inner first ring 28 is actuated to its smaller diameter orientation for placement within the bag 32 and the outer second ring 30 and released to seat within the outer second ring 30, the force existing between the first and second rings 28, 30 retains the plastic collection bag 32 therebetween. As such, one may readily and conveniently remove and replace plastic bags from between the first and second rings 28, 30 through simple actuation of the inner first ring. It is further contemplated that the inner first ring 28 may include a raised portion 29 to permit the inner first ring 28 to be more easily grasped by the user of the device. As shown in FIG. 1, this is a ring which allows for finger insertion.

More particularly, the outer second ring 30 is a substantially rigid member including an inner surface 34 and an outer surface 36. The inner surface 34 is shaped and dimensioned for receiving and supporting the inner first ring 28 as it expands to contact the inner surface 34 of the outer second ring 30. With this in mind, and in accordance with a preferred embodiment of the present invention, the inner surface 34 has an arcuate profile, although those skilled in the art will appreciate that other profiles may be employed without departing from the spirit of the present invention. It is believed the arcuate profile provides for a tight clasping of the first and second rings 28, 30 with any type of bag therebetween.

With regard to the inner first ring 28, it is substantially resilient and includes an inner surface 38 and an outer surface 40. In accordance with a preferred embodiment, the inner first ring 28 is composed of a plastic material. While plastic is disclosed as a preferred material, those skilled in the art will appreciate other materials such as metal could be employed without departing from the spirit of the present invention.

As mentioned above, the inner surface 34 of the outer second ring 30 includes a profile specifically suited for receiving and supporting the inner first ring 28 when it is expanded within the outer second ring 30. With this in mind, the outer surface 40 of the inner first ring 28 is provided with a mating profile. This enhances the interaction between the outer second ring 30 and the inner first ring 28 to help in retaining a collection bag 32 between the first and second rings 28, 30. The mating profile may be in the form of a groove in the outer ring in which the inner ring is positioned. Further, the profile of the outer surface of the inner first ring 28 may be of a raised texture and the inner surface of the outer ring is a mating textured surface. The textured surface could perforate bag 32 and thereby hold more securely therebetween.

In practice, the portable collection device 10 is utilized in the following manner. Prior to walking your dog, a plastic collection bag 32 is secured between the first and second rings 28, 30. In particular, the inner first ring 28 is removed from its position within the outer second ring 30 by compressing, or otherwise, manipulating the resilient inner first ring 28 such that it may be removed from its position frictionally engaged with the inner surface 34 of the outer second ring 30. One such manipulation would be to simply press the inner first ring 28 up out of the outer second ring 30 with your thumbs as your fingers hold the outer second ring 30 down. Once the inner first ring 28 is removed, a collection bag 32 is placed within the space defined by the outer second ring 30. In particular, the collection bag 32 is placed within the space defined by the outer second ring 30 such that the open end 42 of the collection bag 32 is positioned adjacent the inner surface 34 of the outer second ring 30 in a position such that the collection bag 32 may be securely held between the inner first ring 28 and the outer second ring 30. Thereafter, the first inner ring 28 is compressed put into the open end 42 of bag 32, press fit back into the outer second ring 30, or otherwise manipulated, to its smaller configuration such it is adapted to be place within the space defined by the outer second ring 30. The inner first ring 28 is then placed within the outer second ring 30 and released such that the outer surface 40 of the inner first ring 28 seats within the inner surface 34 of the outer second ring 30 in a manner clamping the collection bag 32 between the first and second rings 28, 30.

At this time, the user may follow his dog and when the dog is ready to poop, position the collection bag 32 beneath the dog for collection of the feces. Once the feces are collected, the collection bag 32 may be readily removed from the present device by simply removing the inner first ring 28 from within the outer second ring 30. The collection bag 32 will then be free to slip out from its position within the space defined by the outer second ring 30 and the user may then tie the bag off and dispose of it. Once the used bag is removed, another bag may be secured to the present collection device for later use.

Additional bags may be stored in handle 24. The handle is hollow and includes an end 25 which may be pivoted or rotated to expose an opening in the 24 in which unused bags may be stored.

As those skilled in the art will certainly appreciate, circular rings are disclosed in accordance with a preferred embodiment. However, the rings may be formed in a variety of shapes without departing from the spirit of the present invention.

While the preferred embodiments have been shown and described, it will be understood that there is no intent to limit the invention by such disclosure, but rather, is intended to cover all modifications and alternate constructions falling within the spirit and scope of the invention.

1. A portable collection device for collecting pet feces, comprising:
an elongated, support bat having a first end and a second end;
the first end of the support bat is provided with a handle for gripping by a user;
the second end of the support bar is provided with a bag holder adjustably connected thereto;
the bag holder is composed of an inner first ring and an outer second ring that cooperate to function as a clamp to secure a collection bag therebetween for collection of pet feces.

2. The device according to claim 1, wherein the support bar is adjustable in length.

3. The device according to claim 2, wherein the support bar is telescopically adjustable.

4. The device according to claim 1, wherein the inner first ring includes an inner surface and an outer surface, and the outer surface of the inner first ring is provided with a profile that mates with an inner profile of the outer second ring to enhance the interaction between the outer second ring and the inner first ring to help in retaining a collection bag between the inner first ring and the outer second ring.

5. The device according to claim 4, wherein the profile of the outer surface of the inner first ring is a raised textured surface and the inner surface of the outer second ring is a mating textured surface.

6. The device according to claim 4, wherein the inner first ring and outer second rings are concentrically oriented and maintained in a position such that the inner first ring and the outer second ring stay within the same plane to hold a collection bag therebetween.

7. The device according to claim 6, wherein the outer second ring is substantially rigid and is coupled to the second end of the support bar, and the inner first ring is substantially compliant and resilient allowing the inner first ring to be selectively placed within the outer second ring, wherein when a collection bag is positioned within the outer second ring, the inner first ring is actuated to its smaller diameter orientation for placement within the outer second ring and released to seat within the outer second ring, the force existing between the inner first ring and the outer second ring retains a collection bag therebetween.

8. The device according to claim 7, wherein the outer second ring includes an inner surface with a groove and an outer surface, and the groove of the inner surface is shaped and dimensioned for receiving and supporting the inner first ring therein as it expands to contact the inner surface of the outer second ring.

9. The device according to claim 1, wherein the handle includes a battery operated light.

10. The device according to claim 1, wherein the profile of the outer surface of the inner first ring is a raised textured surface and the inner surface of the outer second ring is a mating textured surface.
